(19) United States
(12) Patent Application Publication
(10) Pub. No.: US 2025/0377811 A1
(43) Pub. Date: Dec. 11, 2025

(54) MANAGED STORAGE ENDPOINT ADAPTED ACTIVATOR

(71) Applicant: Dell Products L.P., Round Rock, TX (US)

(72) Inventors: Chooi Peng Low, Plano, TX (US); Krantisinh Deshmukh, Pune (IN)

(21) Appl. No.: 18/736,334

(22) Filed: Jun. 6, 2024

(51) Int. Cl. G06F 3/06

(52) U.S. Cl. CPC G06F 3/0622; G06F 3/0655; G06F 3/067

(57) ABSTRACT

Techniques described herein relate to a method for operations on storage endpoints. The method includes obtaining, by an endpoint manager, a first operation request associated with a storage endpoint from a user, wherein the storage endpoint is one of a plurality of storage endpoints included in a heterogeneous storage endpoint environment; identifying that the user is associated with the operation request; making, after the identifying, a first determination that the user is not already verified; in response to the first determination: performing endpoint specific user verification based on the storage endpoint to verify the identity of the user; and performing, in response to verifying the identity of the user, an operation associated with the operation request on the storage endpoint.

### BACKGROUND

Computing devices may provide services for users. To provide the services, the computing devices may execute processes that provide at least a portion of the services. The computing devices may coordinate with other computing devices during the execution of the processes. The computing devices in the computing environment may be susceptible to threats from nefarious users. To protect the computing devices and data in the computing environment, the may require users to verify their identity prior to allowing the users to access the computing devices.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a diagram of a system in accordance with one or more embodiments disclosed herein.

FIG. 1.2 shows a diagram of an endpoint manager in accordance with one or more embodiments disclosed herein.

FIG. 2.1 shows a flowchart of a method for performing endpoint management in accordance with one or more embodiments disclosed herein.

FIG. 2.2 shows a flowchart of a method for performing endpoint specific user verification in accordance with one or more embodiments disclosed herein.

FIGS. 3.1-3.3 show examples in accordance with one or more embodiments disclosed herein.

FIG. 4 shows a diagram of a computing device in accordance with one or more embodiments disclosed herein.

### DETAILED DESCRIPTION

Specific embodiments will now be described with reference to the accompanying figures. In the following description, numerous details are set forth as examples of the embodiments disclosed herein. It will be understood by those skilled in the art that one or more embodiments disclosed herein may be practiced without these specific details and that numerous variations or modifications may be possible without departing from the scope of the embodiments disclosed herein. Certain details known to those of ordinary skill in the art are omitted to avoid obscuring the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to methods, systems, and/or non-transitory computer readable mediums for performing central user verification for heterogeneous storage endpoints.

It is difficult for a central storage endpoint management solution, where each managed storage endpoint is its own standalone system, to verify that the user using the central management system is a legitimate user on the endpoint that(s) he is trying to manage. Typically, these management systems depend on single sign-on (SSO) where an identity provider becomes the central provider of user authentication. Sometimes a central authorization server, trusted by both the central server and the storage endpoints, is utilized to bring some commonality to these disparate systems.

Embodiments disclosed herein do not mandate the use of SSO or a central authorization server. Users of the central management server and target storage endpoints may be local users on the management server or the storage endpoints (i.e., user credentials stored locally on these systems). Embodiments disclosed herein include an activator that knows to direct a user to the right endpoint verification application programming interface (API) before the user is allowed to proceed with any management operation on the endpoint via the central management server. User operation on management server may proceed only if target storage endpoint provides a stamp of user legitimacy to the activator. Accordingly, the user may not be required to know the native functionality of each storage endpoint of a heterogeneous storage endpoint environment to perform operations on data stored in the heterogeneous storage endpoint environment without compromising on data security. As such, the efficiency and security of the system may be improved.

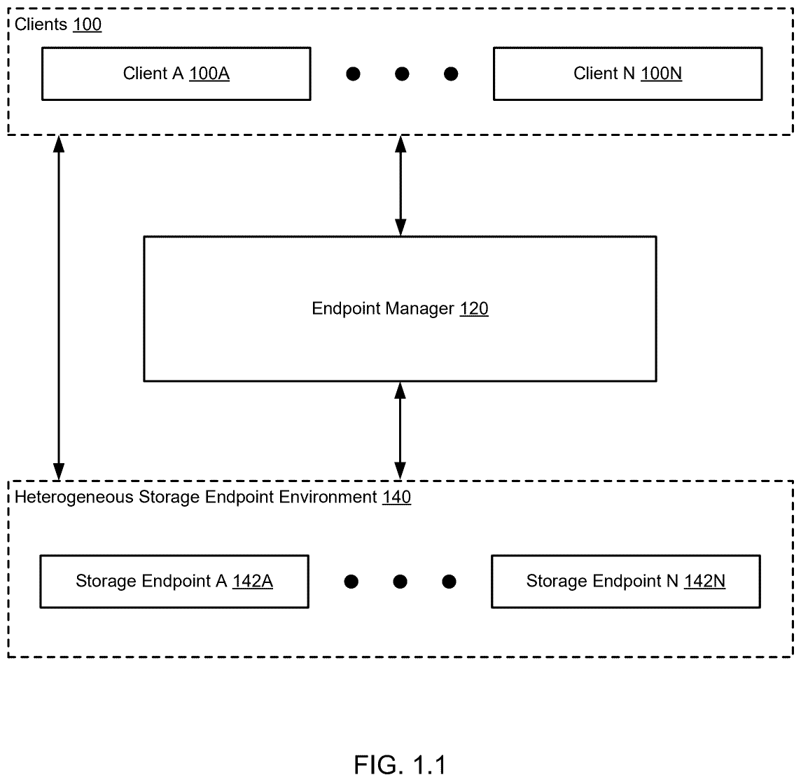

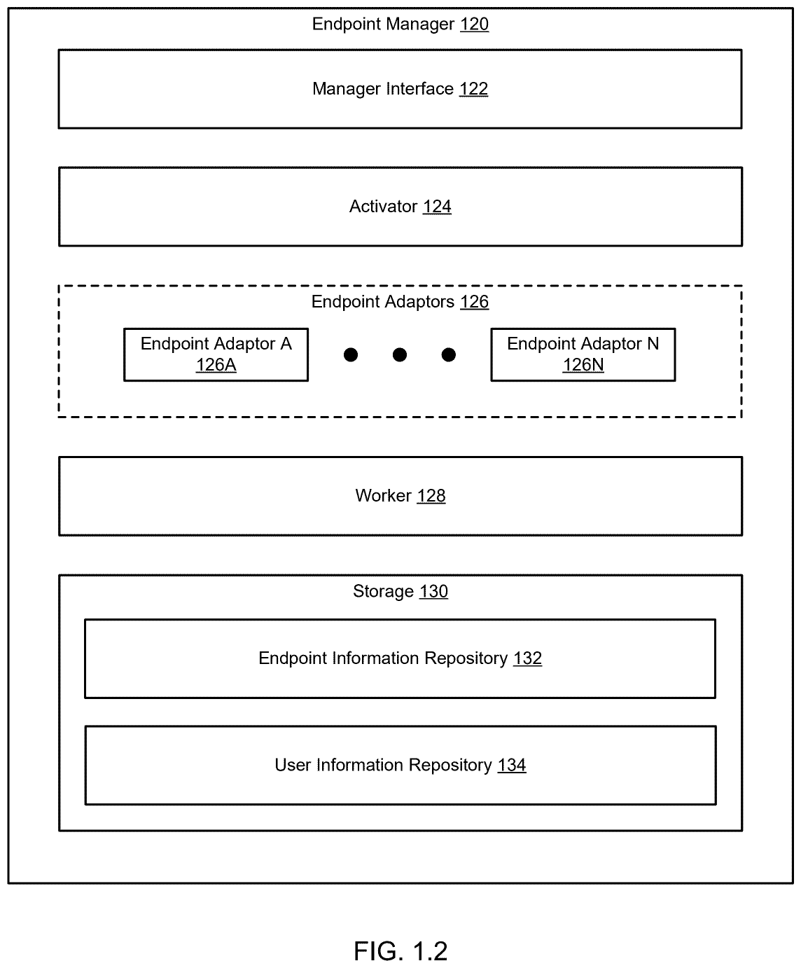

FIG. 1.1 shows a diagram of a system in accordance with one or more embodiments disclosed herein. The system may include clients (100), an endpoint manager (120), and a heterogeneous storage endpoint environment (140). The components of the system illustrated in FIG. 1.1 may be operatively connected to each other and/or operatively connected to other entities (not shown) via any combination of wired (e.g., Ethernet) and/or wireless networks (e.g., local area network, wide area network, Internet, etc.) without departing from embodiments disclosed herein. Each component of the system illustrated in FIG. 1.1 is discussed below.

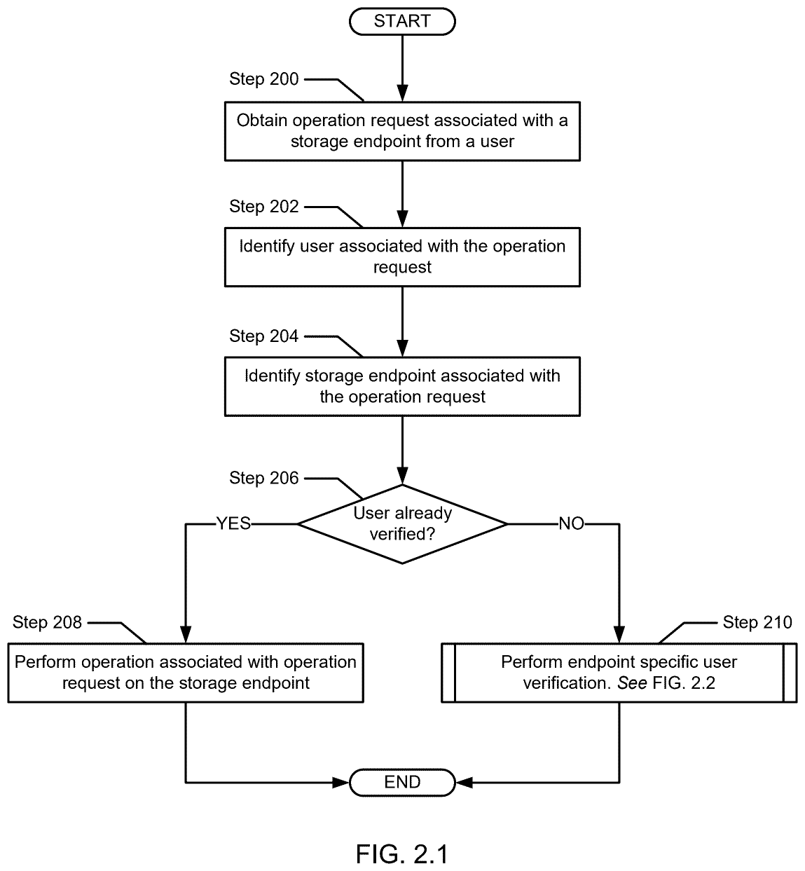

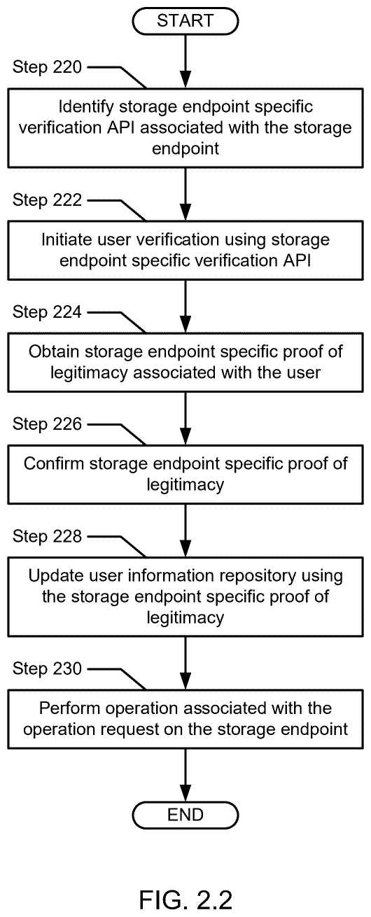

In one or more embodiments, the clients (100) may be configured to include the functionality to perform may perform computer implemented services for users (not shown). The computer implemented services may include any quantity and/or type of computer implemented services without departing from embodiments disclosed herein. The computer implemented services may include, for example, word processing services, calendar services, electronic mail services, machine learning model training services, inferencing services, database services, data processing services, data storage services, etc. To perform the aforementioned computer implemented services, the clients (100) may obtain storage endpoint management services from the endpoint manager (120) and data storage services from the heterogeneous storage endpoint environment (140). The clients (100) may store, delete, read, modify, and/or process data stored on the heterogeneous storage endpoint environment (140) during the performance of computer implemented services. The clients (100) may include the functionality to perform all, or a portion, of the methods discussed in FIGS. 2.1-2.2. The clients (100) may include any quantity of clients, each performing any quantity or type of computer implemented services without departing from embodiments disclosed herein. For example, the clients (100) may include client A (100A) and client N (100N). The clients (100) may include other and/or additional functionalities without departing from embodiments disclosed herein.

In one or more embodiments, a client (e.g., 100A, 100N) of the clients (100) may be implemented using one or more computing devices. In one or more embodiments, a computing device may be any device, portion of a device, or any set of devices capable of electronically processing instructions and may include any number of components, which include, but are not limited to, any of the following: one or more processors (e.g. components that include integrated circuitry) (not shown), memory (e.g., random access memory (RAM)) (not shown), input and output device(s) (not shown), non-volatile storage hardware (e.g., solid-state drives (SSDs), hard disk drives (HDDs) (not shown)), one or more physical interfaces (e.g., network ports, storage ports) (not shown), any number of other hardware components (not shown), accelerators (e.g., GPUs) (not shown), sensors (not shown) for obtaining data, and/or any combination thereof.

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer, automobile computing system, and/or any other mobile computing device), a storage device (e.g., a disk drive array, a fibre/fiber channel storage device, an Internet Small Computer Systems Interface (iSCSI) storage device, a tape storage device, a flash storage array, a network attached storage device, etc.), a network device (e.g., switch, router, multi-layer switch, etc.), a hyper-converged infrastructure, a cluster, a virtual machine, a logical container (e.g., for one or more applications), a cloud resource, and/or any other type of device with the aforementioned requirements.

In one or more embodiments, the non-volatile storage (not shown) and/or memory (not shown) of a computing device or system of computing devices may be one or more data repositories for storing any number of data structures storing any amount of data (i.e., information). In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, any non-volatile storage (not shown) and/or memory (not shown) of a computing device or system of computing devices may be considered, in whole or in part, as non-transitory computer readable mediums, which may store software and/or firmware.

Such software and/or firmware may include instructions which, when executed by the one or more processors (not shown) or other hardware (e.g., circuitry) of a computing device and/or system of computing devices, cause the one or more processors and/or other hardware components to perform operations in accordance with one or more embodiments described herein.

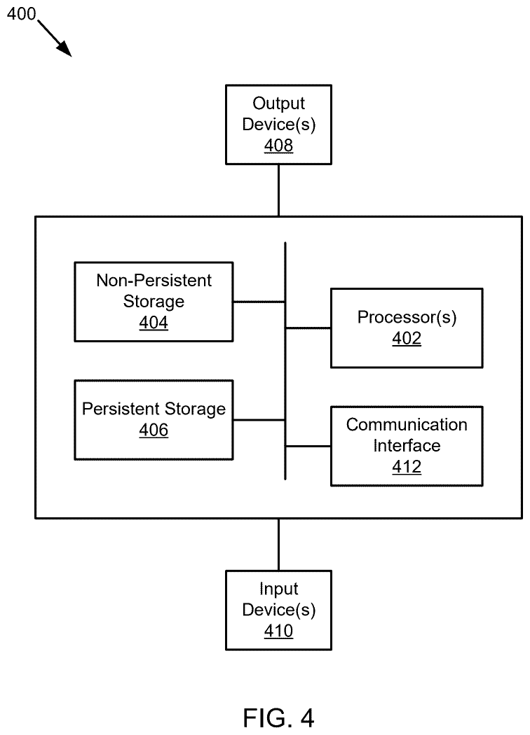

The software instructions may be in the form of computer readable program code to perform, when executed, methods of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium. For additional information regarding computing devices, refer to FIG. 4.

The clients (100) may be implemented using logical devices without departing from the embodiments disclosed herein. For example, the clients (100) may include virtual machines that utilize computing resources of any number of physical computing devices to provide the functionality of the clients (100). The clients (100) may be implemented using other types of logical devices without departing from the embodiments disclosed herein.

In one or more embodiments, the endpoint manager (120) may be configured to include the functionality to perform endpoint management services for the clients (100) and the heterogeneous storage endpoint environment (140). The endpoint manager (120) may include the functionality to perform the methods of FIGS. 2.1-2.2. For additional information regarding the endpoint manager, refer to FIG. 1.2. The endpoint manager (120) may include other and/or additional functionalities without departing from embodiments disclosed herein.

In one or more embodiments, the endpoint manager (120) may be implemented using one or more computing devices. The computing devices may be embodiments of computing devices discussed above and in FIG. 4.

In one or more embodiments, the endpoint manager (120) may be implemented using logical devices without departing from the embodiments disclosed herein. For example, the endpoint manager (120) may include virtual machines that utilize computing resources of any number of physical computing devices to provide the functionality of the endpoint manager (120). The endpoint manager (120) may be implemented using other types of logical devices without departing from the embodiments disclosed herein.

In one or more embodiments disclosed herein, the heterogeneous storage endpoint environment (140) may include the functionality to provide data storage services for the clients (100). The data storage services may include storing, providing, and/or updating data based on requests originating from users of the clients (100) and performed, or initiated, by the endpoint manager (120). To perform the data storage services, the heterogeneous storage endpoint environment (140) may include any quantity of storage endpoints (e.g., storage endpoint A (142A), storage endpoint N (142N), etc.). For example, the heterogeneous storage endpoint environment (140) may include storage endpoint A (142A) and storage endpoint N (142N). Each storage endpoint (e.g., storage endpoint A (142A), storage endpoint N (142N), etc.) may be configured to include the functionality to perform a portion of the data storage services of the heterogeneous storage endpoint environment. The heterogeneous storage endpoint environment (140) and the storage endpoints (e.g., storage endpoint A (142A), storage endpoint N (142N), etc.) may include other and/or additional functionalities without departing from embodiments disclosed herein.

As discussed above, the heterogeneous storage endpoint environment (140) may perform data storage services for users of the clients (100). Accordingly, users of clients (100) may submit operation requests to the endpoint manager (120) to perform operations on a storage endpoint (e.g., storage endpoint A (142A), storage endpoint N (142N), etc.) of the heterogeneous storage endpoint environment (140). The operations may include, for example, read operations, write operations, delete operations, and/or any other type of storage operations without departing from embodiments disclosed herein. To perform operations associated with operation requests submitted by users, the endpoint manager (120) may verify or authenticate a user's identity with the storage endpoint (e.g., storage endpoint A (142A), storage endpoint N (142N), etc.) associated with the operation request to ensure security.

However, each storage endpoint (e.g., storage endpoint A (142A), storage endpoint N (142N), etc.) may be associated with a particular storage endpoint type. Each storage endpoint type may include its own native functionality that may be used to perform user verification. For example, each storage endpoint type may include its own application programming interfaces (APIs), proof of legitimacies, etc. As such, the endpoint manager (120) may transform or invoke the native functionality of each storage endpoint (e.g., storage endpoint A (142A), storage endpoint N (142N), etc.) when a user submits a generic operation request associated with each endpoint as is shown in the methods of FIGS. 2.1-2.2. Accordingly, the user may not be required to know the native functionality of each storage endpoint (e.g., storage endpoint A (142A), storage endpoint N (142N), etc.) of the heterogeneous storage endpoint environment (140) to perform operations on data stored in the heterogeneous storage endpoint environment (140) without compromising on data security.

In one or more embodiments, a storage endpoint of the storage endpoints (e.g., 142A, 142N, etc.) of the heterogeneous storage endpoint environment (140) may be implemented using one or more computing devices. The computing devices may be embodiments of the computing devices discussed above and in FIG. 4.

In one or more embodiments, the storage endpoints (e.g., 142A, 142N, etc.) may be implemented using logical devices without departing from the embodiments disclosed herein. For example, the storage endpoints (e.g., 142A, 142N, etc.) may include virtual machines that utilize computing resources of any number of physical computing devices to provide the functionality of the storage endpoints (e.g., 142A, 142N, etc.). The storage endpoints (e.g., 142A, 142N, etc.) may be implemented using other types of logical devices without departing from the embodiments disclosed herein.

In one or more embodiments, as discussed above, the components of the system of FIG. 1.1 may be operatively connected via a network (not shown). The network may be implemented using may be implemented using one or more computing devices. A computing device may be, for example, a mobile phone, tablet computer, laptop computer, desktop computer, server, distributed computing system, or a cloud resource. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) because the computing device to perform the functions of the network described herein and/or all, or a portion, of the methods illustrated in FIGS. 2.1-2.2. The network may be implemented using other types of computing devices without departing from the embodiments disclosed herein. For additional details regarding computing devices, refer to FIG. 4.

The network may be implemented using logical devices without departing from the embodiments disclosed herein. For example, the network may include virtual machines that utilize computing resources of any number of physical computing devices to provide the functionality of the network. The network may be implemented using other types of logical devices without departing from the embodiments disclosed herein.

In one or more embodiments, the network may represent a (decentralized or distributed) computing network and/or fabric configured for computing resource and/or messages exchange among registered computing devices (e.g., the clients (100), the endpoint manager (120), and the storage endpoints (e.g., 142A, 142N) of the heterogeneous storage endpoint environment (140)). As discussed above, components of the system may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network may be implemented using any combination of wired and/or wireless network topologies, and the network may be operably connected to the Internet or other networks. Further, the network may enable interactions between, for example, the clients (100), the endpoint manager (120), the storage endpoints (e.g., 142A, 142N) of the heterogeneous storage endpoint environment (140), and/or other entities not shown in FIG. 1.1 through any number and type of wired and/or wireless network protocols (e.g., TCP, UDP, IPv4, etc.).

The network may encompass various interconnected, network-enabled subcomponents (not shown) (e.g., switches, routers, gateways, cables etc.) that may facilitate communications between the components of the system. In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network and its subcomponents may be implemented using hardware, software, or any combination thereof.

In one or more embodiments, before communicating data over the network, the data may first be broken into smaller batches (e.g., data packets) so that larger size data can be communicated efficiently. For this reason, the network-enabled subcomponents may break data into data packets. The network-enabled subcomponents may then route each data packet in the network to distribute network traffic uniformly.

In one or more embodiments, the network-enabled subcomponents may decide how real-time (e.g., on the order of milliseconds or less) network traffic and non-real-time network traffic should be managed in the network. In one or more embodiments, the real-time network traffic may be high-priority (e.g., urgent, immediate, etc.) network traffic. For this reason, data packets of the real-time network traffic may need to be prioritized in the network. The real-time network traffic may include data packets related to, for example (but not limited to): videoconferencing, web browsing, voice over Internet Protocol (VOIP), etc.

As used herein, “communication” may refer to simple data passing, or may refer to two or more components coordinating a job. As used herein, the term “data” is intended to be broad in scope. In this manner, that term embraces, for example (but not limited to): data segments that are produced by data stream segmentation processes, data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

Although the system of FIG. 1.1 is shown as having a certain number of components (e.g., 100, 100A, 100N, 120, 140, 142A, 142N), in other embodiments disclosed herein, the system may have more or fewer components. For example, the functionality of each component described above may be split across components or combined into a single component. Further still, each component may be utilized multiple times to carry out an iterative operation.

FIG. 1.2 shows a diagram of an endpoint manager (120) in accordance with one or more embodiments disclosed herein. The endpoint manager (120) may be an embodiment of the endpoint manager (120, FIG. 1.1) discussed above. As discussed above, the endpoint manager (120) may include the functionality to perform endpoint management services for users of clients (100, FIG. 1.1) and storage endpoints (e.g., 142A, 142N, FIG. 1.1). To perform the aforementioned services, the endpoint manager (120) may include a manager interface (122), an activator (124), endpoint adaptors (126), a worker (128), and storage (130). The endpoint manager (120) may include fewer, additional, or other components without departing from embodiments disclosed herein. Each of the components of endpoint manager (120) is discussed below.

In one or more embodiments, a manager interface (122) may represent one or more APIs (e.g., a communication channel, an entry point, etc.) for the endpoint manager (120) and/or storage endpoints (e.g., 142A, 142N, FIG. 1.1) of the heterogeneous storage endpoint environment (140, FIG. 1.1). To that extent, the manager interface (122) may be configured to include the functionality to employ one or more set of subroutine definitions, protocols, and/or hardware/software components for enabling communications between endpoint manager (120) and external entities (e.g., the clients (e.g., 100, FIG. 1.1), storage endpoints (e.g., 142A, 142N, FIG. 1.1) of the heterogeneous storage endpoint environment (140, FIG. 1.1), etc.). The manager interface (122) may also be configured to include the functionality to receive and validate (in conjunction with the activator (124) and endpoint adaptors (126)) communications from external entities. The manager interface (122) may include other and/or additional functionalities without departing from embodiments disclosed herein.

In one or more embodiments, the manager interface (122) may be implemented as one or more physical devices. A physical device may include circuitry. A physical device may be, for example, a field-programmable gate array, application specific integrated circuit, programmable processor, microcontroller, digital signal processor, or other hardware processor. The physical device may be configured to provide the functionality of the manager interface (122) described throughout this Detailed Description.

In one or more embodiments disclosed herein, the manager interface (122) may be implemented as computer instructions, e.g., computer code, stored on a storage (e.g., 130) that when executed by a processor of the endpoint manager (120) causes the endpoint manager (120) to provide the functionality of the manager interface (122) described throughout this Detailed Description.

In one or more embodiments, manager interface (122) may be implemented using any combination of hardware and software without departing from embodiments disclosed herein.

In one or more embodiments, the activator (124) may be configured to perform a portion of the endpoint management services of the endpoint manager (120). The portion of the endpoint management services performed by the activator may include determining whether users associated with operation requests have been previously verified, invoking the worker (128) to perform the operation requests for verified users, and/or identifying endpoint adaptors (126) based on the storage endpoints associated with operation requests to facilitate user verification. The activator (124) may further include the functionality to maintain (generate, update, modify, delete, etc.) the user information repository (134). The activator (124) may include the functionality to perform at least a portion of the methods discussed in FIGS. 2.1-2.2. The activator (124) may include other and/or additional functionalities without departing from embodiments disclosed herein.

In one or more embodiments, the activator (124) may be implemented as one or more physical devices. A physical device may include circuitry. A physical device may be, for example, a field-programmable gate array, application specific integrated circuit, programmable processor, microcontroller, digital signal processor, or other hardware processor. The physical device may be configured to provide the functionality of the activator (124) described throughout this detailed description.

In one or more embodiments disclosed herein, the activator (124) may be implemented as computer instructions, e.g., computer code, stored on a storage (e.g., 130) that when executed by a processor of the endpoint manager (120) causes the endpoint manager (120) to provide the functionality of the activator (124) described throughout this Detailed Description.

In one or more embodiments, the endpoint adaptors (126) may be configured to include the functionality to perform a portion of the endpoint management services performed by the endpoint manager (120). The portion of the endpoint management services performed by the endpoint adaptors (126) may include generating and maintaining endpoint type entries included in the endpoint information repository (132) and facilitating user verification using the native functionality of specific storage endpoint types. The endpoint adaptors (126) may include any quantity of endpoint adaptors (e.g., 126A, 126N) without departing from embodiments disclosed herein. Each endpoint adaptor (e.g., 126A, 126N) may be associated with a particular storage endpoint type. Accordingly, each endpoint adaptor (e.g., 126A, 126N) may facilitate user verification for a particular storage endpoint type. For example, endpoint adaptor A (126A) may be associated with a first storage endpoint type and endpoint adaptor N (126N) may be associated with a second storage endpoint type. The endpoint adaptors (126) may include the functionality to perform at least a portion of the methods discussed in FIGS. 2.1-2.2. The endpoint adaptors (126) may include other and/or additional functionalities without departing from embodiments disclosed herein.

In one or more embodiments, each endpoint adaptor (e.g., 126A, 126N) may be implemented as one or more physical devices. A physical device may include circuitry. A physical device may be, for example, a field-programmable gate array, application specific integrated circuit, programmable processor, microcontroller, digital signal processor, or other hardware processor. The physical device may be configured to provide the functionality of the corresponding endpoint adaptor (e.g., 126A, 126N) described throughout this detailed description.

In one or more embodiments disclosed herein, each endpoint adaptor (e.g., 126A, 126N) may be implemented as computer instructions, e.g., computer code, stored on a storage (e.g., 130) that when executed by a processor of the endpoint manager (120) causes the endpoint manager (120) to provide the functionality of each endpoint adaptor (e.g., 126A, 126N) described throughout this Detailed Description.

In one or more embodiments, the worker (128) may be configured to include the functionality to perform, or initiate performance of, the operation requests associated with verified users on the targeted storage endpoints (e.g., 142A, 142N, FIG. 1.1) of the heterogeneous storage endpoint environment (140, FIG. 1.1), etc.). As such, the worker (128) may perform any operations corresponding to the operation requests without departing from embodiments disclosed herein. For example, the worker (128) may write data, read data, update data, modify data, delete data, etc. from the storage endpoints (e.g., 142A, 142N, FIG. 1.1) of the heterogeneous storage endpoint environment (140, FIG. 1.1), etc.). The worker (128) may include the functionality to perform at least a portion of the methods discussed in FIGS. 2.1-2.2. The worker (128) may include other and/or additional functionalities without departing from embodiments disclosed herein.

In one or more embodiments, the storage (130) may be implemented using one or more volatile or non-volatile storages or any combination thereof. The storage (130) may include the functionality to, or otherwise be configured to, store and provide all, or portions, of information that may be used by the manager interface (122), the activator (124), the endpoint adaptors (126), and the worker (128). The information stored in the storage (130) may include an endpoint information repository (132) and a user information repository (134). The storage (130) may include other and/or additional information without departing from embodiments disclosed herein. Each of the aforementioned types of information is discussed below.

In one or more embodiments, the endpoint information repository (132) may include one or more data structures that include storage endpoint entries. Each storage endpoint entry may be associated with a storage endpoint of the heterogeneous storage endpoint environment (e.g., 140, FIG. 1.1). Each entry may include a storage endpoint identifier, storage endpoint specific verification API, a storage endpoint specific proof of legitimacy, verification information, and communication information associated with the storage endpoint corresponding with the storage endpoint entry. The verification information may specify any information that may be used to prove a user's identity as required by the storage endpoint during user verification, such as, for example, a username, a password, a pin code, a phone number, an email address, security questions and answers, biometric information (e.g., finger print, face scan, etc.), etc. The communication information may include any information that may enable communication with the corresponding storage endpoint without departing from embodiments disclosed herein. The communication information may include network addresses, port numbers, encryption keys, digital certificates, etc. The storage endpoint entries may include other and/or additional information without departing from embodiments disclosed herein. The storage endpoint entries may be generated by the activator using information obtained by users (e.g., system administrators) or storage endpoints when storage endpoints are added to the system of FIG. 1.1. The storage endpoint entries may be used by the activator (124) and/or the endpoint adaptors (126) to perform user verification for storage endpoints as discussed in FIGS. 2.1-2.2. The endpoint information repository may include other and/or additional information and may be used for other and/or additional purposes without departing from embodiments disclosed herein.

As used herein, storage endpoint specific verification API may refer to one or more sets of subroutine definitions, API calls, protocols, parameters, and/or hardware/software components for enabling user verification communications between the corresponding storage endpoint (e.g., 142A, 142N, FIG. 1.1) and external entities (e.g., the clients (e.g., 100, FIG. 1.1) and the endpoint manager (120). Each storage endpoint, or each storage endpoint type, may include its own native functionalities including storage endpoint specific verification API.

In one or more embodiments, the user information repository (134) may include one or more data structures that include user entries associated with users of the clients (100, FIG. 1.1). Each user entry may include information associated with a user of the system. The information may include a user identifier associated with the user, a client identifier associated with a client used by the user, and communication information associated with the client. The communication information may include any information that may enable communication with the corresponding client and user without departing from embodiments disclosed herein. The communication information may include network addresses, port numbers, encryption keys, digital certificates, etc. Each user entry may further include one or more storage endpoint specific proof of legitimacies. The user information repository may be generated and updated by the activator (124) using information obtained from users of clients (100) and/or storage endpoints (e.g., 142A, 142N) during the performance of user verification. The user information repository (134) may be used by the activator (124) to perform user verification. The user information repository (134) may include other and/or additional information and may be used for other and/or additional purposes without departing from embodiments disclosed herein.

As used herein, a storage endpoint specific proof of legitimacy may refer to a data structure that may be used to indicate that a storage endpoint associated with the storage endpoint specific proof of legitimacy has verified the identity of the user corresponding to the storage endpoint specific proof of legitimacy. The storage endpoint specific proof of legitimacy may specify the storage endpoint (e.g., include the corresponding storage endpoint identifier) and the user (e.g., include the corresponding user identifier) associated with the storage endpoint specific proof of legitimacy. Each storage endpoint type may include similar or different types of storage endpoint specific proof of legitimacy. The storage endpoint specific proof of legitimacy may be implemented as cryptographic token. The cryptographic token may be embedded within a session cookie associated with an active communication session between the user and the storage endpoint. The activator (124) may delete a storage endpoint specific proof of legitimacy when they (or the corresponding communication session associated with the storage endpoint specific proof of legitimacy) ends or expires. A storage endpoint specific proof of legitimacy may include other and/or additional information and may be implemented using other and/or additional data structures without departing from embodiments disclosed herein.

As used herein, a user may refer to any human or non-human that may, through the clients (100, FIG. 1.1), generate and/or send operation requests to the endpoint manager (120) to perform operations on storage endpoints (e.g., 142A, 142N) of the heterogeneous storage endpoint environment (140) without departing from embodiments disclosed herein. A human user may refer to a human (e.g., a local user, a system administrator, etc.) that interfaces with the clients (100, FIG. 1.1) via user interfaces to obtain computer implemented services from the clients (100, FIG. 1.1). A non-human user may refer to any machine, service, application, workflow, etc. executing on the clients (100, FIG. 1.1). A non-human user may be used in scripted, background jobs of the clients (100, FIG. 1.1). Both human and non-human users may be verified using the methods discussed in FIGS. 2.1-2.2 without departing from embodiments disclosed herein.

While the data structures (e.g., 132, 134) and other data structures mentioned in this Detailed Description are illustrated/discussed as separate data structures and have been discussed as including a limited amount of specific information, any of the aforementioned data structures may be divided into any number of data structures, combined with any number of other data structures, and may include additional, less, and/or different information without departing from embodiments disclosed herein. Additionally, while illustrated as being stored in the storage (140), any of the aforementioned data structures may be stored in different locations (e.g., in storage of other computing devices) and/or spanned across any number of computing devices without departing from embodiments disclosed herein. The data structures discussed in this Detailed Description may be implemented using, for example, file systems, lists, linked lists, tables, unstructured data, databases, etc.

FIG. 2.1 shows a flowchart of a method for performing endpoint management in accordance with one or more embodiments disclosed herein. The method shown in FIG. 2.1 may be performed by, for example, an endpoint manager (e.g., 120, FIG. 1.1). Other components of the system in FIGS. 1.1-1.2 may perform all, or a portion, of the method of FIG. 2.1 without departing from the scope of the embodiments described herein. While FIG. 2.1 is illustrated as a series of steps, any of the steps may be omitted, performed in a different order, additional steps may be included, and/or any or all of the steps may be performed in a parallel and/or partially overlapping manner without departing from the scope of the embodiments described herein.

Initially, in Step 200, an operation request associated with a storage endpoint is obtained from a user. In one or more embodiments, the activator of the endpoint manager may obtain the operation request from a client used by a user (e.g., via the manager interface of the endpoint manager). The user may generate and initiate the transmission of the operation request by the client. The operation request may specify an operation to perform on a storage endpoint of the heterogeneous storage endpoint environment. The operation request may be obtained from the client using any appropriate method of data transmission without departing from embodiments disclosed. For example, the operation request may be obtained as a message including one or more network packets through one or more network devices that operatively connect the client to the endpoint manager. An operation request associated with a storage endpoint may be obtained from a user via other and/or additional methods without departing from embodiments disclosed herein.

In Step 202, the user associated with the operation request is identified. In one or more embodiments, the operation request may include a user identifier associated with the user that generated the operation request. In one or more embodiments, the activator of the endpoint manager may parse the operation request to obtain the user identifier included in the operation request. The user corresponding to the obtained user identifier included in the operation request may be identified as the user associated with the operation request. The user associated with the operation request may be identified via other and/or additional methods without departing from embodiments disclosed herein.

In Step 204, a storage endpoint associated with the operation request is identified. In one or more embodiments, the operation request may include a storage endpoint identifier associated with the storage endpoint targeted by the operation request. In one or more embodiments, the activator of the endpoint manager may parse the operation request to obtain the storage endpoint identifier included in the operation request. The storage endpoint corresponding to the obtained storage endpoint identifier included in the operation request may be identified as the storage endpoint associated with the operation request. The storage endpoint associated with the operation request may be identified via other and/or additional methods without departing from embodiments disclosed herein.

In Step 206, a determination is made as to whether the user is already verified. In one or more embodiments, the activator may identify a user entry of the user information repository associated with the user. As discussed above, the user entry may include one or more active proofs of legitimacy associated with one or more storage endpoints that have verified the user's identity (e.g., via the methods of FIG. 2.2.). Each proof of legitimacy may include the storage endpoint identifier associated with the storage endpoint corresponding to the proof of legitimacy. The activator may check the one or more proofs of legitimacy to determine if one includes the storage endpoint identifier identified in Step 204. In one or more embodiments disclosed herein, if the activator identifies a proof of legitimacy associated with the user and the storage endpoint, then the activator may determine that the user is already verified. In one or more embodiments disclosed herein, if the activator does not identify a proof of legitimacy associated with the user and the storage endpoint, then the activator may determine that the user is already verified. The determination as to whether the user is already verified may be made via other and/or additional methods without departing from embodiments disclosed herein.

In one or more embodiments disclosed herein, if it is determined that the user is already verified, then the method proceeds to Step 208. In one or more embodiments disclosed herein, if it is determined that the user is not already verified, then the method proceeds to Step 210.

In Step 208, the operation associated with the operation request is performed on the storage endpoint. In one or more embodiments, the operation request may include an operation. The activator may initiate performance of the operation by the worker of the endpoint manager. The worker may then perform, or initiate performance of, the operation on the storage endpoint. Accordingly, the worker may perform, for example, one or more read operations, write operations, delete operations, and/or any other type of storage operations on the storage endpoint as specified by the operation request without departing from embodiments disclosed herein. The operation associated with the operation request may be performed on the storage endpoint via other and/or additional methods without departing from embodiments disclosed herein.

In one or more embodiments disclosed herein, the method ends following Step 208.

In Step 210, endpoint specific user verification is performed. In one or more embodiments, endpoint specific user verification may be performed via the methods discussed in FIG. 2.2. For additional information regarding performing endpoint specific user verification, refer to FIG. 2.2.

In one or more embodiments disclosed herein, the method ends following Step 210.

FIG. 2.2 shows a flowchart of a method for performing endpoint specific user verification in accordance with one or more embodiments disclosed herein. The method shown in FIG. 2.2 may be performed by, for example, an endpoint manager (e.g., 120, FIG. 1.1). Other components of the system in FIGS. 1.1-1.2 may perform all, or a portion, of the method of FIG. 2.2 without departing from the scope of the embodiments described herein. While FIG. 2.2 is illustrated as a series of steps, any of the steps may be omitted, performed in a different order, additional steps may be included, and/or any or all of the steps may be performed in a parallel and/or partially overlapping manner without departing from the scope of the embodiments described herein.

Initially, in Step 220, storage endpoint specific verification API associated with the storage endpoint is identified. As discussed above, the endpoint information repository may include storage endpoint entries. The storage endpoint entries may include a storage endpoint identifier associated with the corresponding storage endpoint and an endpoint adaptor associated with the corresponding endpoint. The storage endpoint entries may also include the storage endpoint specific verification API associated with the corresponding storage endpoint that may be used to perform user verification. Accordingly, the activator may parse the endpoint information repository to identify a storage endpoint entry that includes a storage endpoint identifier that matches the storage endpoint identifier associated with the targeted storage endpoint. The activator may identify the storage endpoint specific verification API included in the identified storage endpoint entry as the storage endpoint specific verification API associated with the storage endpoint. Storage endpoint specific verification API associated with the storage endpoint may be identified via other and/or additional methods without departing from embodiments disclosed herein.

In Step 222, user verification using the storage endpoint specific verification API is initiated. In one or more embodiments, the activator may instruct the endpoint adaptor associated with the storage endpoint (e.g., as specified by the storage endpoint entry of the endpoint information repository) to initiate user verification. In one or more embodiments, the endpoint adaptor may then prompt or instruct the user to perform user verification using the storage endpoint specific verification API. In alternative embodiments, the endpoint adaptor may perform user verification using the storage endpoint specific verification API and verification information (which may be different from one storage endpoint to another) associated with the user. As such, in one embodiment, the endpoint adaptor may provide the appropriate storage endpoint API calls to the client such that the user may submit the appropriate storage endpoint specific verification API calls to the storage endpoint to perform user verification directly. In an alternative embodiment, the endpoint adaptor may obtain necessary verification information (e.g., username, password, pin code, biometric information, phone number, email address, etc.) to provide proof of user identity and the endpoint adaptor may perform the storage endpoint specific verification API calls using the verification information associated with the user to perform indirect user verification. The user verification using the storage endpoint specific verification API may be initiated via other and/or additional methods without departing from embodiments disclosed herein.

In Step 224, a storage endpoint specific proof of legitimacy associated with the user is obtained. In one or more embodiments, in response to performing the storage endpoint specific verification API to perform user verification, the storage endpoint may verify the user's identity and generate a storage endpoint specific proof of legitimacy associated with the user. The storage endpoint specific proof of legitimacy may indicate that the storage endpoint has successfully verified the user's identity.

In one embodiment, for scenarios in which the user directly performed user verification using the storage endpoint specific verification API calls provided by the endpoint adaptor, the storage endpoint may send the storage endpoint specific proof of legitimacy to the client used by the user. The client may then send the proof of legitimacy to the endpoint manager. In an alternative embodiment, for scenarios in which the endpoint adaptor performed indirect user verification using verification information obtained from the user, the storage endpoint may send the storage endpoint specific proof of legitimacy to the endpoint manager. The storage endpoint specific proof of legitimacy associated with the user may be obtained via other and/or additional methods without departing from embodiments disclosed herein.

In Step 226, the storage endpoint specific proof of legitimacy is confirmed. In one or more embodiments, the activator of the endpoint manager may confirm the storage endpoint specific proof of legitimacy by verifying that the storage endpoint specific proof of legitimacy was obtained from the storage endpoint and is associated with the user. Accordingly, the activator may check the storage endpoint specific proof of legitimacy to verify that the storage endpoint identifier associated with the storage endpoint, the user identifier associated with the user, and/or the client identifier associated with the client identifier associated with the client are included in the storage endpoint specific proof of legitimacy. If necessary, the activator (or endpoint adaptor) may decrypt the storage endpoint specific proof of legitimacy to perform the confirmation. The storage endpoint specific proof of legitimacy may be confirmed via other and/or additional methods without departing from embodiments disclosed herein.

In Step 228, the user information repository is updated using the storage endpoint specific proof of legitimacy. In one or more embodiments, the activator may check the user information repository for a user entry associated with the user using the user identifier. In one or more embodiments, if the user information repository already includes a user entry associated with the user, the activator may update the user entry by including the storage endpoint specific proof of legitimacy in the user entry. In one or more embodiments, if the user information repository does not include a user entry associated with the user, the activator may generate a user entry and include the storage endpoint specific proof of legitimacy in the generated user entry. As such, the storage endpoint specific proof of legitimacy included in the user entry of the user information repository may be used for performing user verification for future operation requests submitted by the user targeting the storage endpoint. The user information repository may be updated using the storage endpoint specific proof of legitimacy via other and/or additional methods without departing from embodiments disclosed herein.

In Step 230, the operation associated with the operation request is performed on the storage endpoint. The operation associated with the operation request may be performed on the storage endpoint via the methods of Step 206 of FIG. 2.1. For additional information regarding performing the operation associated with the operation request on the storage endpoint, refer to FIG. 2.1.

In one or more embodiments disclosed herein, the method ends following Step 230.

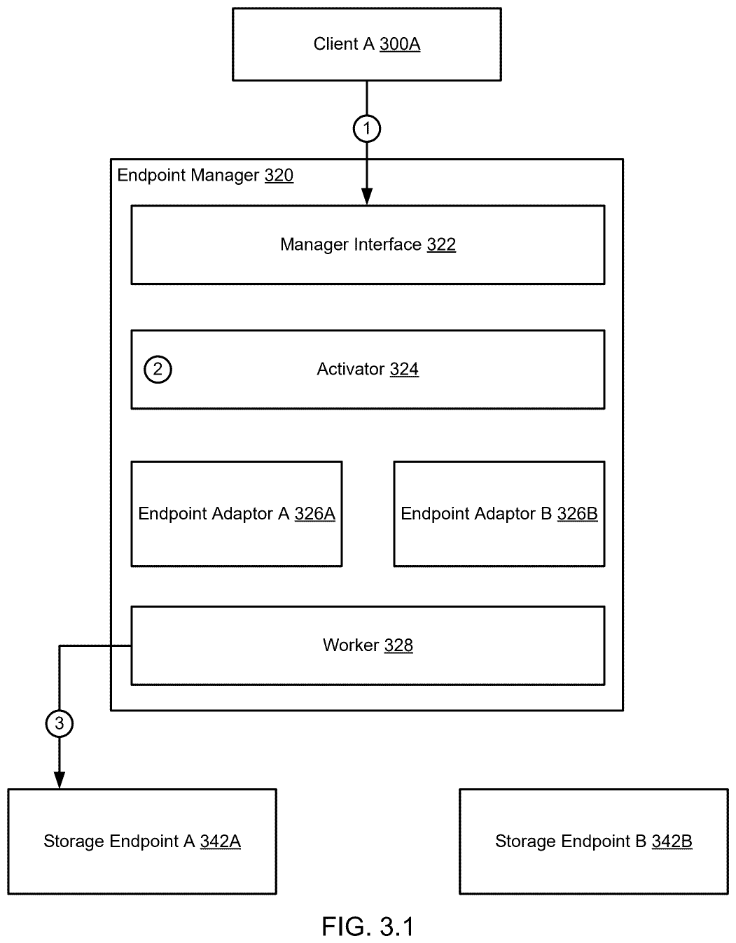

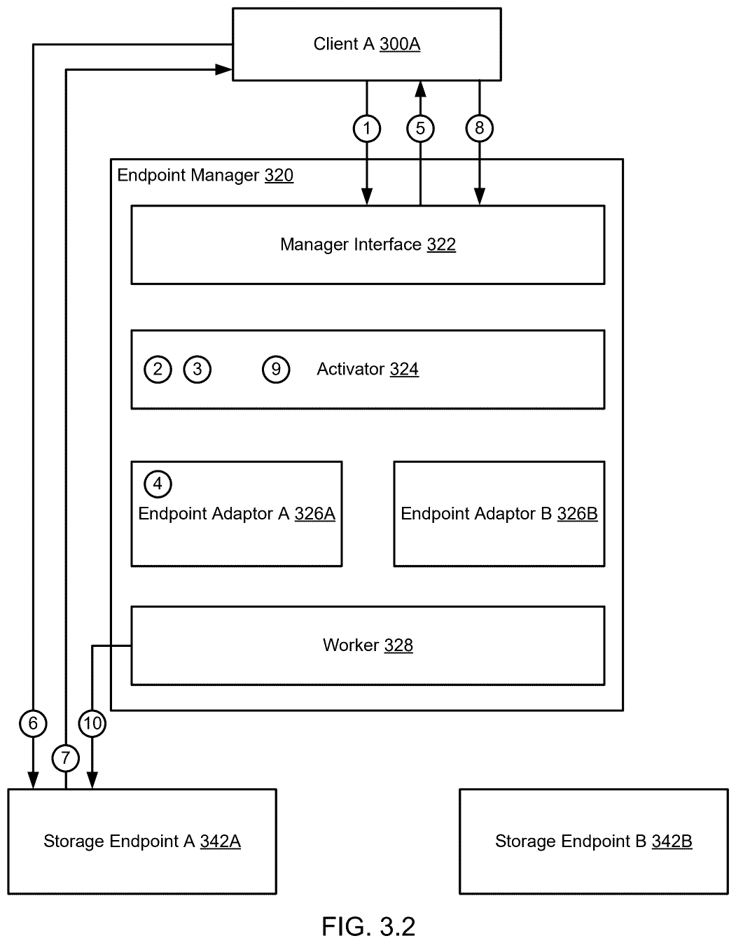

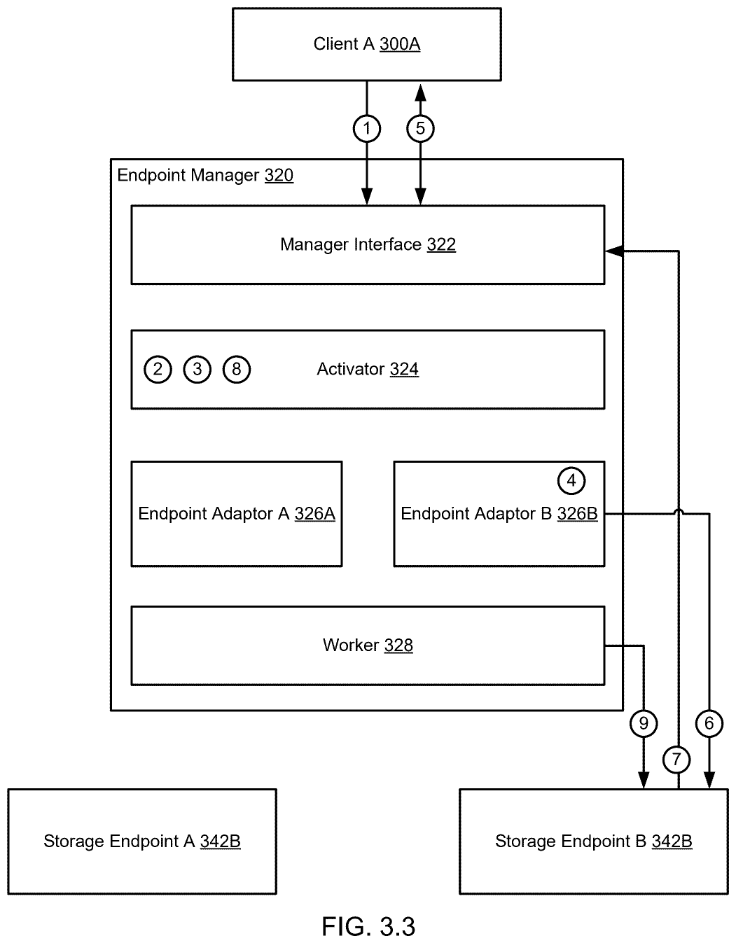

To further clarify embodiments of the invention, FIGS. 3.1-3.3 show examples in accordance with one or more embodiments disclosed herein.

### Start of Example

The examples illustrated in FIGS. 3.1-3.3 are not intended to limit the scope of the embodiments disclosed herein and are independent from any other examples discussed in this application. FIGS. 3.1-3.3 illustrate examples of performing user verification for different storage endpoint types.

Turning now to FIG. 3.1, FIG. 3.1 shows a diagram of a first example. For the sake of brevity, not all components involved in the example system may be discussed in FIG. 3.1.

The example system includes client A (300A), an endpoint manager (320), storage endpoint A (342A), and storage endpoint B (342B). The endpoint manager (320) may include a manager interface (322), an activator (324), endpoint adaptor A (326A), endpoint adaptor B, and a worker (328). The components of the example system may be operatively connected to each other via one or more networks (not shown).

At a first point in time, at Step 1, the user of client A (300A) sends an operation request to write data on storage endpoint A (342A) to the endpoint manager (320) via the manager interface (322). In response to obtaining the request, the activator (324) identifies a user entry in a user information repository (not shown) associated with the user. In Step 2, the activator (324) determines that the user entry includes an active storage endpoint specific proof of legitimacy associated with the user and storage endpoint A (342A) and that the user has already been verified. As a result, in Step 3, the worker (328) performs the operation associated with the operation request by writing data to storage endpoint A (342A).

Turning now to FIG. 3.2, FIG. 3.2 shows a diagram of a second example. For the sake of brevity, not all components involved in the example system may be discussed in FIG. 3.2.

The example system includes client A (300A), an endpoint manager (320), storage endpoint A (342A), and storage endpoint B (342B). The endpoint manager (320) may include a manager interface (322), an activator (324), endpoint adaptor A (326A), endpoint adaptor B, and a worker (328). The components of the example system may be operatively connected to each other via one or more networks (not shown).

At a first point in time, at Step 1, the user of client A (300A) sends an operation request to write data on storage endpoint A (342A) to the endpoint manager (320) via the manager interface (322). In response to obtaining the request, the activator (324) identifies a user entry in a user information repository (not shown) associated with the user. In Step 2, the activator (324) determines that the user entry does not include an active storage endpoint specific proof of legitimacy associated with the user and storage endpoint A (342A) and that the user has already been verified. As a result, in Step 3, the activator (324) identifies the storage endpoint specific verification API associated with storage endpoint A (342A).

At Step 4, the activator instructs endpoint adaptor A (326A), which is associated with storage endpoint A (342A), to initiate user verification using the storage endpoint specific verification API associated with storage endpoint A (342A). As a result, in Step 5, endpoint adaptor A (326A) sends the storage endpoint specific verification API to the user of client A (300A) through the manager interface (322). In response to obtaining the storage endpoint specific verification API, in Step 6, the user performs user verification using the storage endpoint specific verification API, which includes making a “/login” API call with the user's username and password as required by storage endpoint A (342A). In Step 7, storage endpoint A (342A) generates a storage endpoint specific proof of legitimacy in response to the API call and sends the storage endpoint specific proof of legitimacy to client A (300A). In Step 8, client A (300A) sends the storage endpoint specific proof of legitimacy to the activator (324) through the manager interface (322). In response to obtaining the storage endpoint specific proof of legitimacy, in Step 9, the activator (324) confirms the storage endpoint specific proof of legitimacy and instructs the worker (328) to perform the operation request on storage endpoint A (342A). As a result, in Step 10, the worker (328) performs the operation associated with the operation request by writing data to storage endpoint A (342A).

Turning now to FIG. 3.3, FIG. 3.3 shows a diagram of a third example. For the sake of brevity, not all components involved in the example system may be discussed in FIG. 3.3.

The example system includes client A (300A), an endpoint manager (320), storage endpoint A (342A), and storage endpoint B (342B). The endpoint manager (320) may include a manager interface (322), an activator (324), endpoint adaptor A (326A), endpoint adaptor B, and a worker (328). The components of the example system may be operatively connected to each other via one or more networks (not shown).

At a first point in time, at Step 1, the user of client A (300A) sends an operation request to write data on storage endpoint B (342B) to the endpoint manager (320) via the manager interface (322). In response to obtaining the request, the activator (324) identifies a user entry in a user information repository (not shown) associated with the user. In Step 2, the activator (324) determines that the user entry does not include an active storage endpoint specific proof of legitimacy associated with the user and storage endpoint B (342B) and that the user has already been verified. As a result, in Step 3, the activator (324) identifies the storage endpoint specific verification API associated with storage endpoint B (342B).

At Step 4, the activator instructs endpoint adaptor B (326B), which is associated with storage endpoint B (342B), to initiate user verification using the storage endpoint specific verification API associated with storage endpoint B (342B). As a result, in Step 5, endpoint adaptor B (326B) requests and obtains verification information associated with storage endpoint B (342B) including a pin code and a phone number associated with the user to the user of client A (300A) through the manager interface (322). In response to obtaining the verification information, in Step 6, the endpoint adaptor B (326B) performs user verification using the storage endpoint specific verification API, which includes making a “/authenticate” API call with the user's pin code and a phone number. In Step 7, storage endpoint B (342B) generates a storage endpoint specific proof of legitimacy in response to the API call and sends the storage endpoint specific proof of legitimacy to the endpoint manager (320) through the manager interface (322). In response to obtaining the storage endpoint specific proof of legitimacy, in Step 8, the activator (324) confirms the storage endpoint specific proof of legitimacy and instructs the worker (328) to perform the operation request on storage endpoint B (342B). As a result, in Step 9, the worker (328) performs the operation associated with the operation request by writing data to storage endpoint B (342B).

### End of Example

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

As used herein, an entity that is programmed to, or configured to, perform a function (e.g., step, action, etc.) refers to one or more hardware devices (e.g., processors, digital signal processors, field programmable gate arrays, application specific integrated circuits, etc.) that provide the function. The hardware devices may be programmed to do so by, for example, being able to execute computer instructions (e.g., computer code) that cause the hardware devices to provide the function. In another example, the hardware device may be programmed to do so by having circuitry that has been adapted (e.g., modified) to perform the function. An entity that is programmed to perform a function does not include computer instructions in isolation from any hardware devices. Computer instructions may be used to program a hardware device that, when programmed, provides the function.

As used herein, an identifier associated with an entity may refer to a unique combination of alphanumeric characters that may be used to specify the entity from other entities of the same type. The identifier may include any combination of alphanumeric characters without departing from embodiments disclosed herein. The identifier may be global (known to all components of the system) or local (e.g., component specific such as a file identifier local to a computing device that is not known to other computing devices) without departing from embodiments disclosed herein.

The problems discussed above should be understood as being examples of problems solved by embodiments of the invention of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as of the invention. Accordingly, the scope of the invention should be limited only by the attached claims.

What is claimed is:

1. A method for performing operations on storage endpoints, comprising:
obtaining, by an endpoint manager, a first operation request associated with a storage endpoint from a user, wherein the storage endpoint is one of a plurality of storage endpoints included in a heterogeneous storage endpoint environment;
identifying that the user is associated with the operation request;
making, after the identifying, a first determination that the user is not already verified;
in response to the first determination:
performing endpoint specific user verification based on the storage endpoint to verify the identity of the user; and
performing, in response to verifying the identity of the user, an operation associated with the operation request on the storage endpoint.

2. The method of claim 1, wherein the heterogeneous storage endpoint environment comprises a first storage endpoint type and a second storage endpoint type.

3. The method of claim 2, wherein the first storage endpoint type comprises a first user verification application programming interface (API) and the second storage endpoint type comprises a second user verification API.

4. The method of claim 2, wherein the first storage endpoint type comprises a first proof of legitimacy type and the second storage endpoint type comprises a second proof of legitimacy type.

5. The method of claim 1, wherein performing endpoint specific user verification based on the storage endpoint to verify the identity of the user comprises:
identifying a storage endpoint specific user verification API associated with the storage endpoint;
initiating user verification using the storage specific user verification API;
as part of the user verification:
obtaining a storage endpoint specific proof of legitimacy associated with the user;
confirming the storage endpoint specific proof of legitimacy; and
updating a user information repository using the storage endpoint specific proof of legitimacy.

6. The method of claim 5, further comprising:
obtaining, by the endpoint manager, a second operation request associated with the storage endpoint from a second user;
identifying that the second user is associated with the operation request;
making a second determination that the second user is already verified; and
in response to the second determination:
performing an operation associated with the second operation request on the storage endpoint.

7. The method of claim 6, wherein making the second determination that the second user is already verified comprises identifying a second proof of legitimacy associated with the second user and the storage endpoint in the user information repository.

8. A non-transitory computer readable medium comprising computer readable program code, which when executed by a computer processor enables the computer processor to perform a method for performing operations on storage endpoints, the method comprising:
obtaining, by an endpoint manager, a first operation request associated with a storage endpoint from a user, wherein the storage endpoint is one of a plurality of storage endpoints included in a heterogeneous storage endpoint environment;
identifying that the user is associated with the operation request;
making, after the identifying, a first determination that the user is not already verified;
in response to the first determination:
performing endpoint specific user verification based on the storage endpoint to verify the identity of the user; and
performing, in response to verifying the identity of the user, an operation associated with the operation request on the storage endpoint.

9. The non-transitory computer readable medium of claim 8, wherein the heterogeneous storage endpoint environment comprises a first storage endpoint type and a second storage endpoint type.

10. The non-transitory computer readable medium of claim 9, wherein the first storage endpoint type comprises a first user verification application programming interface (API) and the second storage endpoint type comprises a second user verification API.

11. The non-transitory computer readable medium of claim 9, wherein the first storage endpoint type comprises a first proof of legitimacy type and the second storage endpoint type comprises a second proof of legitimacy type.

12. The non-transitory computer readable medium of claim 8, wherein performing endpoint specific user verification based on the storage endpoint to verify the identity of the user comprises:
identifying a storage endpoint specific user verification API associated with the storage endpoint;
initiating user verification using the storage specific user verification API;
as part of the user verification:
obtaining a storage endpoint specific proof of legitimacy associated with the user;
confirming the storage endpoint specific proof of legitimacy; and
updating a user information repository using the storage endpoint specific proof of legitimacy.

13. The non-transitory computer readable medium of claim 12, wherein the method further comprising:
obtaining, by the endpoint manager, a second operation request associated with the storage endpoint from a second user;
identifying that the second user is associated with the operation request;
making a second determination that the second user is already verified; and
in response to the second determination:
performing an operation associated with the second operation request on the storage endpoint.

14. The non-transitory computer readable medium of claim 13, wherein making the second determination that the second user is already verified comprises identifying a second proof of legitimacy associated with the second user and the storage endpoint in the user information repository.

15. A system for performing operations on storage endpoints, the system comprising:
a heterogeneous storage endpoint environment; and
a endpoint manager, comprising a processor and memory comprising computer instructions, which when executed by the processor causes the processor to perform a method, wherein the method comprises:
obtaining a first operation request associated with a storage endpoint from a user, wherein the storage endpoint is one of a plurality of storage endpoints included in the heterogeneous storage endpoint environment;
identifying that the user is associated with the operation request;
making, after the identifying, a first determination that the user is not already verified;
in response to the first determination:
performing endpoint specific user verification based on the storage endpoint to verify the identity of the user; and
performing, in response to verifying the identity of the user, an operation associated with the operation request on the storage endpoint.

16. The system of claim 15, wherein the heterogeneous storage endpoint environment comprises a first storage endpoint type and a second storage endpoint type.

17. The system of claim 16, wherein the first storage endpoint type comprises a first user verification application programming interface (API) and the second storage endpoint type comprises a second user verification API.

18. The system of claim 16, wherein the first storage endpoint type comprises a first proof of legitimacy type and the second storage endpoint type comprises a second proof of legitimacy type.

19. The system of claim 15, wherein performing endpoint specific user verification based on the storage endpoint to verify the identity of the user comprises:
identifying a storage endpoint specific user verification API associated with the storage endpoint;
initiating user verification using the storage specific user verification API;
as part of the user verification:
obtaining a storage endpoint specific proof of legitimacy associated with the user;
confirming the storage endpoint specific proof of legitimacy; and
updating a user information repository using the storage endpoint specific proof of legitimacy.

20. The system of claim 19, wherein the method further comprises:
obtaining, by the endpoint manager, a second operation request associated with the storage endpoint from a second user;
identifying that the second user is associated with the operation request;
making a second determination that the second user is already verified; and
in response to the second determination:
performing an operation associated with the second operation request on the storage endpoint.
